(19) United States
(12) Patent Application Publication
(10) Pub. No.: US 2007/0143535 A1
(43) Pub. Date: Jun. 21, 2007

(54) Memory apparatus

(75) Inventors: Shigeto Kitamura, Kawasaki (JP); Yasunori Izumiya, Kawasaki (JP); Takeshi Nishimiya, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/389,553

(22) Filed: Mar. 24, 2006

(30) Foreign Application Priority Data
Dec. 15, 2005 (JP) 2005-362069

(51) Int. Cl. G06F 13/00; G06F 12/00

(52) U.S. Cl. 711/104; 711/103

(57) ABSTRACT

A memory apparatus adding a non-volatile memory based on the T13 proposal to a storage medium controller controlling read/write operations of data between a host computer and a storage medium through a volatile memory without an accompanying increase in the number of pins or increase in size, which memory apparatus further introduces an interface control function unit which controls interfacing for compatibility with a volatile memory (SDRAM) and is configured to support the function of control of the non-volatile memory (flash memory) through a volatile memory controller in a storage medium controller.

### BACKGROUND OF THE INVENTION

1. Field of the Invention

The present invention relates to a memory apparatus having a volatile memory, a non-volatile memory, and a storage medium and further provided with a storage medium controller for controlling read/write operations with respect to these memory media, for example, relates to a memory apparatus based on the “Non Volatile Cache Command Proposal for ATA8-ACS” presented by Microsoft Corporation before the Technical Committee T13 (hereinafter referred to as the “T13 proposal”).

Therefore, below, the explanation will be given, for example, assuming the volatile memory to be a synchronous DRAM (SDRAM), the storage medium to be a hard disk (HD), and the storage medium controller to be a hard disk controller (HDC).

2. Description of the Related Art

As will be explained later with reference to FIG. 13, in the past, control of read/write operations between a host computer and hard disk by a hard disk controller had been performed via the SDRAM.

As opposed to this, the T13 proposal proposed that the hard disk controller control the read/write operations by cooperating with a flash memory or other non-volatile memory in addition to the SDRAM. That is, a volatile cache and non-volatile cache would be both used to try to realize a higher performance memory apparatus.

Note that as known art relating to the present invention, there are Japanese National Publication (A) No. 2005-500643, Japanese Patent Publication (A) No. 2004-311002, and Japanese Patent Publication (A) No. 2003-124432. However, the known art disclosed in Japanese National Publication (A) No. 2005-500643 discloses an SDRAM compatible synchronous flash memory device and a method of control of an SDRAM compatible synchronous flash memory device alone. This differs from a method of control for when using an SDRAM compatible flash memory device and an SDRAM in combination and for when using a single memory device combining a flash memory device and an SDRAM based on the present invention described in detail later.

Further, the known art disclosed in Japanese Patent Publication (A) No. 2004-311002 has as its object the storage of operational modes etc. in a non-volatile memory (FeRAM) at the time of control of an SDRAM and the reduction of the program codes when the power is turned on and is characterized by having a switching controller for securing SRAM/flash compatibility and by having an Fe RAM in that controller. The present invention described in detail later is not provided with a non-volatile memory for storing operational codes and is not an invention for securing compatibility with a flash memory like Japanese Patent Publication (A) No. 2004-311002, but is an invention for controlling a flash memory provided with an SDRAM compatible interface, so differs from Japanese Patent Publication (A) No. 2004-311002.

Further, the known art disclosed in Japanese Patent Publication (A) No. 2003-124432 is an invention of a memory device mounting an SDRAM and SRAM or flash memory in a single package and is characterized by dividing the address pins and data pins of the SDRAM and SRAM or flash memory for enabling parallel operation, but in the present invention described in detail later, an SDRAM compatible flash memory is used to make the address and data pins common in use, so there is no parallel operation like in Japanese Patent Publication (A) No. 2003-124432.

As explained above, in a storage medium controller (hard disk controller) using both a conventional volatile cache (SDRAM) and new non-volatile cache (flash memory) for controlling read/write operations with respect to a storage medium (hard disk), in addition to the existing volatile memory interface, it is necessary to provide a new non-volatile memory interface.

This being the case, in addition to the several dozen pins necessary for the existing volatile memory interface, several dozen pins have to be added for the non-volatile memory interface.

For this reason, the existing storage medium controller suffers from the problems that (i) the number of pins are greatly increased, (ii) the package of the storage memory controller is changed and increased in size, and (iii) in particular in hard disk drives handling hard disks of 2.5″ or smaller size, the huge number of interconnects accompanying the pins makes complicated patterns necessary and restricts mounting.

### SUMMARY OF THE INVENTION

Accordingly, an object of the present invention is to provide a memory apparatus able to accommodate a new additional non-volatile memory interface without requiring major changes to the circuit configuration of a storage medium controller having an existing volatile memory interface.

To attain the above object, the memory apparatus of the present invention further introduces an interface control function unit (10). This function unit (10) controls interfacing for compatibility with a volatile memory (SDRAM) (4) and is configured to support the function of control of the non-volatile memory (flash memory) (8) through a volatile memory controller (6) in a storage medium controller (2).

### BRIEF DESCRIPTION OF THE DRAWINGS

These and other objects and features of the present invention will become clearer from the following description of the preferred embodiments given with reference to the attached drawings, wherein:

FIG. 1 is a diagram showing a first aspect of the basic configuration of a memory apparatus according to the present invention;

FIG. 2 is a diagram showing a second aspect of the basic configuration of a memory apparatus according to the present invention;

FIG. 3 is a simplified diagram of the first aspect of FIG. 1;

FIG. 4 is a simplified diagram of the second aspect of FIG. 2;

FIG. 5 is a diagram showing more specifically a one-chip memory 13 of FIG. 4;

FIG. 6 is a diagram showing an example of the method of selection of two memories 4, 8 in FIG. 5;

FIG. 7 is a diagram showing an example of the flow of processing of a write command in the case based on the T13 proposal;

FIG. 8 is a diagram showing a specific example of a memory I/F control function unit 10 in FIG. 2 along with its periphery;

FIG. 9 is a timing chart of a first aspect of a main operation of a timing adjuster 22;

FIG. 10 is a timing chart of a second aspect of a main operation of a timing adjuster 22;

FIG. 11 is a diagram showing a first aspect of a memory apparatus 1′ using a copy controller 31 according to the present invention;

FIG. 12 is a diagram showing a second aspect of a memory apparatus 1′ using a copy controller 31 according to the present invention;

FIG. 13 is a diagram showing a conventional memory apparatus; and

FIG. 14 is a diagram showing a memory apparatus based on the T13 proposal.

### DESCRIPTION OF THE PREFERRED EMBODIMENTS

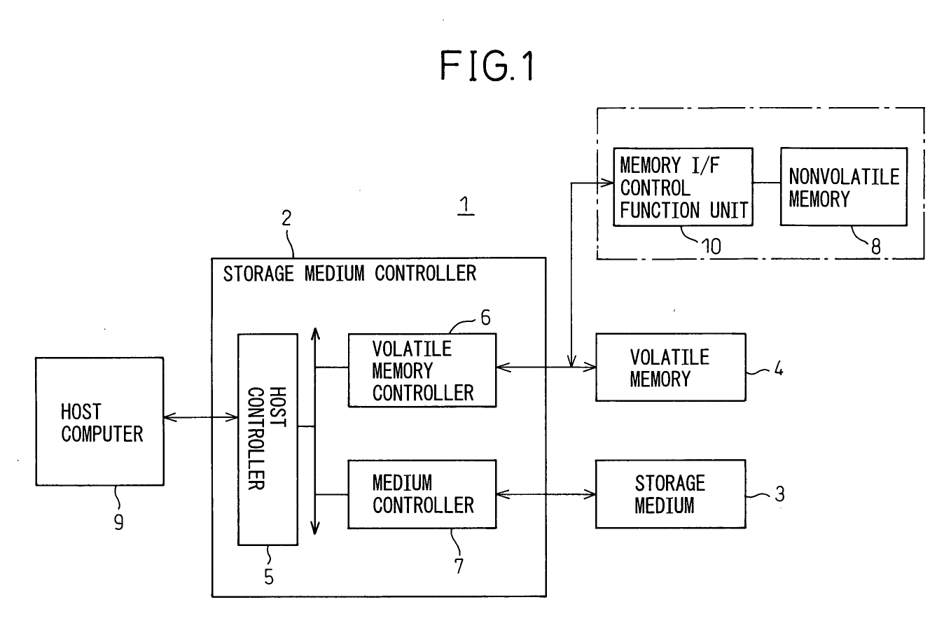

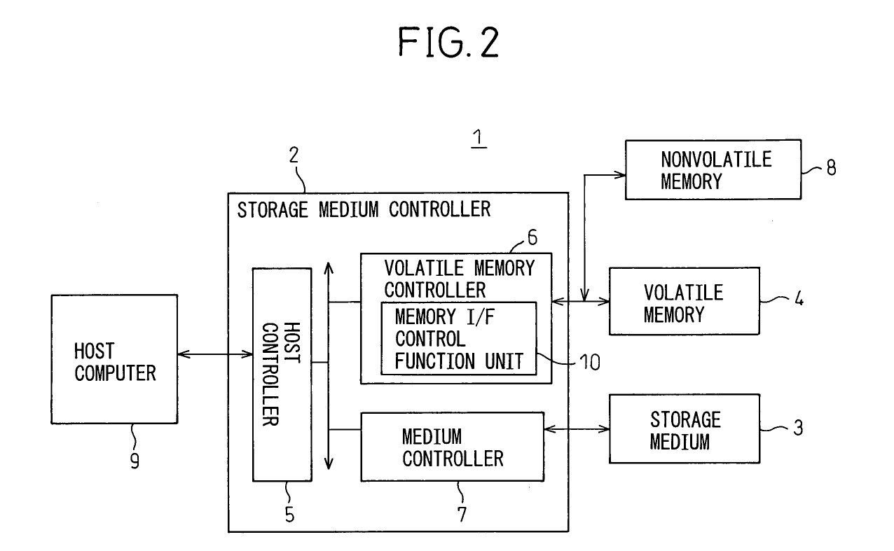

Preferred embodiments of the present invention will be described in detail below while referring to the attached drawings. FIG. 1 and FIG. 2 are diagrams showing first and second aspects of the basic configuration of a memory apparatus according to the present invention. The memory apparatuses 1 shown in FIG. 1 and FIG. 2 have basically the following configurations.

That is, each is provided with a volatile memory 4 for temporarily storing data to be transferred between a host computer 9 and a storage medium 3, an interface able to connect with an interface for connecting with a volatile memory controller 6 for controlling interfacing between the host computer 9 and the volatile memory 4, and a non-volatile memory 8 able to compatibly interface with the volatile memory 4.

In this case, the memory apparatus 1 is provided with a memory interface (I/F) control function unit 10 for controlling interfacing with the non-volatile memory 8 through the volatile memory controller 6. Note that the memory interface control function unit 10 is not particularly limited in location, but in the example of FIG. 1 is shown provided near the non-volatile memory 8.

Note that in a preferred example of the present invention, the storage medium 3 is a hard disk, the volatile memory 4 is an SDRAM, the non-volatile memory is a flash memory, and the storage medium controller 2 is a hard disk controller. The following explanation will be given referring to this preferred example.

Looking at the blocks showing the characterizing features of the present invention in the memory apparatuses 1 shown in FIG. 1 and FIG. 2, the characterizing block is the memory interface function unit (in the figure, shown as the “memory I/F control function unit”). This function unit 10 is provided in the existing memory apparatus 1.

The memory I/F control function unit 10 may be formed outside of the existing volatile memory controller 6 near the non-volatile memory 8 or may be formed inside the volatile memory controller 6. The former first aspect is shown in FIG. 1, while the latter second aspect is shown in FIG. 2. In short, the memory interface (I/F) control function unit 10 may be formed in the storage medium controller 2 or the memory interface (I/F) control function unit 10 may be formed outside of the storage medium controller 2.

However, in both of the first and second aspects, the memory I/F control function unit 10 has the same role. That is, the memory I/F control function unit

supports the non-volatile memory control function for controlling interfacing having compatibility with the volatile memory 4 through the volatile memory controller 6.

Accordingly, a memory apparatus 1 combining an SDRAM (4) and a flash memory (8) having an SDRAM interface is realized, there is no need for making major changes in the circuit configuration of the existing hard disk controller (2), and addition of a flash memory (8) based on the T13 proposal becomes possible. That is,

(i) the number of pins of the hard disk controller (2) remains the same,

(ii) the size of the package of the hard disk controller (2) also remains substantially the same, and

(iii) the interconnect patterns for the interconnects leading to the pins also remain the same.

Since the flash memory (8) can further be accommodated, for example, it is possible to easily incorporate the configuration based on the T13 proposal to a hard disk drive (HDD) provided with a small for example 2.5″ or less hard disk.

Before explaining the best mode of working the present invention, the related art of the memory apparatus according to the present invention will be further clarified.

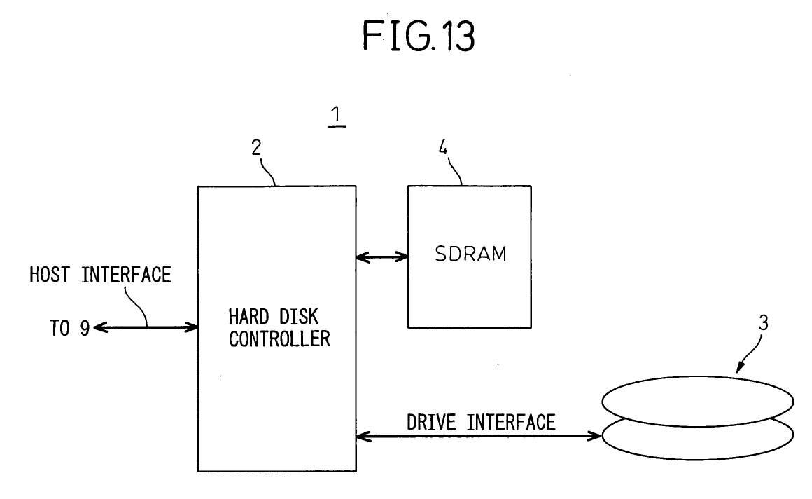

FIG. 13 is a diagram of a conventional memory apparatus. Note that throughout the drawings, similar components are assigned the same reference numerals or symbols.

In the figure, in the conventional memory apparatus 1, the read/write operations of data between the host computer 9 and hard disk 3 are performed through a cache memory constituted by the SDRAM by the hard disk controller 2. This basic configuration is the same as in the present invention shown in FIG. 1 and FIG. 2. Therefore, the hard disk controller 2 in FIG. 13 is specifically comprised of, like shown in FIG. 1 and FIG. 2, a host controller 5, a volatile memory (SDRAM) controller 6, and a medium (hard disk) controller 7.

The SDRAM 4 is interposed in this way for the purposes of acting as a cache memory for the large capacity, but slow access speed hard disk 3 and of adjusting the access speed to the host computer 9 (an SDRAM is much faster than a hard disk).

On the other hand, improvements have been proposed for the conventional memory apparatus 1 shown in FIG. 13. These improvements are contained in the above-mentioned T13 proposal. This is shown by the figures.

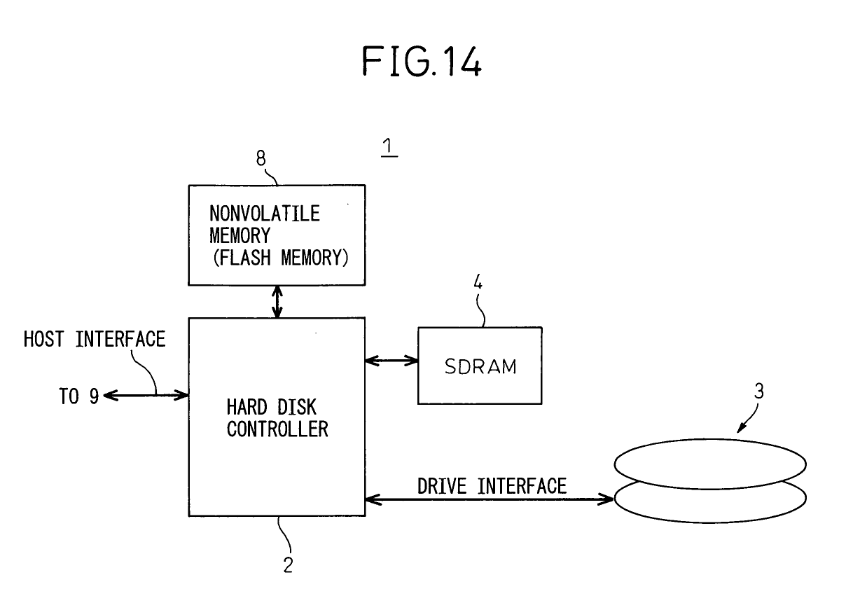

FIG. 14 is a view of an example of a memory apparatus 1 based on the T13 proposal. As shown in the figure, the T13 proposal proposes to additionally mount a non-volatile memory (flash memory) 8 in the hard disk drive (HDD). Note that as the non-volatile memory, there is also an EEPROM. As the flash memory, Nand types and Nor types are being widely used.

By jointly using the flash memory 8 in this way, if writing the necessary data, for example, a boot program, in the flash memory 8, when turning on the power of the HDD, the host computer 9 will read the program directly from the flash memory 8. Therefore, the host computer 9 can start up without having to drive the rotation of the storage medium (hard disk) 3. This has the effect that the time for operating the motor of the HDD and reaching a predetermined speed becomes unnecessary and therefore the startup can be further accelerated. Further, since the motor is not operated, naturally the effect is also obtained that the power consumption can be reduced.

While the above effects can be expected according to the memory apparatus 1 (FIG. 14) based on the T13 proposal, as already explained, the problems arise of an increase in the number of pins, an increase in package size, and complication of the interconnect patterns due to the addition of the flash memory 8.

The above problems are solved by the memory apparatus 1 of the present invention. This has the basic configuration shown in FIG. 1 and FIG. 2. Simplified diagrams of this will however be referred to so as to explain embodiments of the memory apparatus 1 according to the present invention.

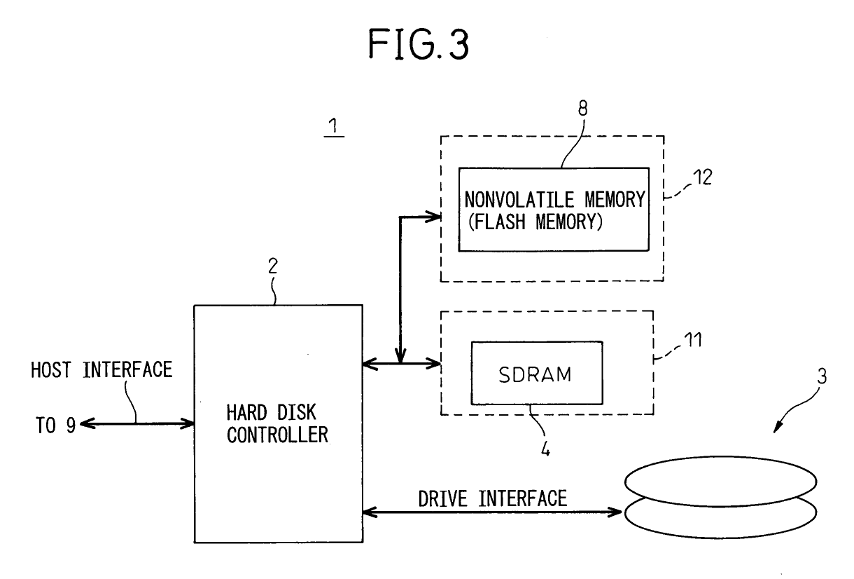

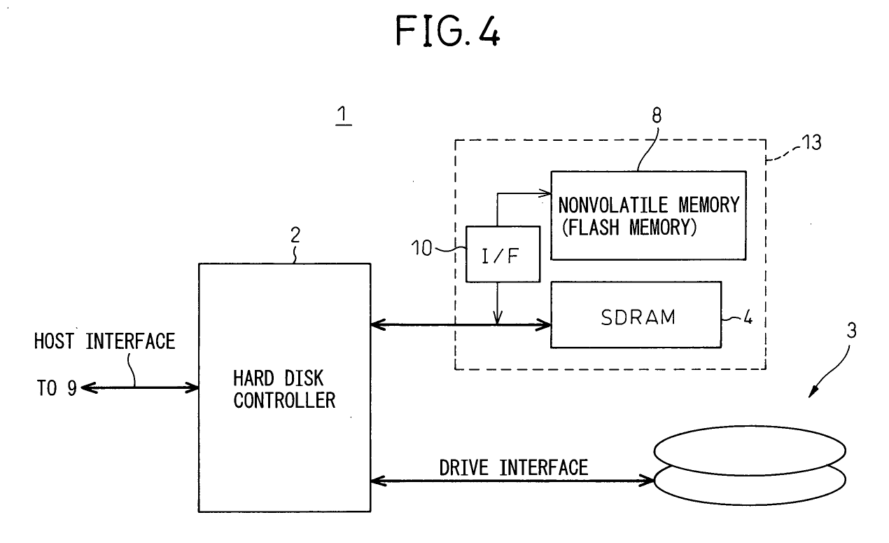

FIG. 3 is a simplified diagram of the first aspect of FIG. 1, while FIG. 4 is a simplified diagram of the second aspect of FIG. 2.

First, referring to FIG. 3, in the memory apparatus 1 of the first aspect, the volatile memory (SDRAM) 4 and the non-volatile memory (flash memory) 8 are comprised of separate memory chips 11 and 12.

On the other hand, in the memory apparatus 1 of the second aspect shown in FIG. 4, first, the volatile memory (SDRAM) 4 and the non-volatile memory (flash memory) 8 are comprised of a one-chip memory 13 integrally provided with a volatile memory 4 area and a non-volatile memory 8 area. More preferably, the memory interface (I/F) control function unit 10 is also integrally formed in the one-chip memory 13.

At the present time, as explained above, as non-volatile memories, manufacturers are supplying EEPROMs, Nand types, and Nor types. There has yet to be any non-volatile memory supporting an SDRAM interface however. According to the present invention, a non-volatile memory can be connected on a conventional SDRAM interface. That is, the SDRAM 4 is provided with a chip select terminal. Due to this, it becomes possible to switch between the chips used, no increase in the number of pins of the hard disk controller (HDC) 2 is incurred, the HDC 2 used up to now does not have to be changed, and the functions proposed in the T13 proposal can be realized. Further, in FIG. 4, the non-volatile memory (flash memory) 8 and the SDRAM 4 are integrated. Due to this, the restrictions in mounting the non-volatile memory 8 can be eliminated. The configuration of FIG. 4 will be further explained below.

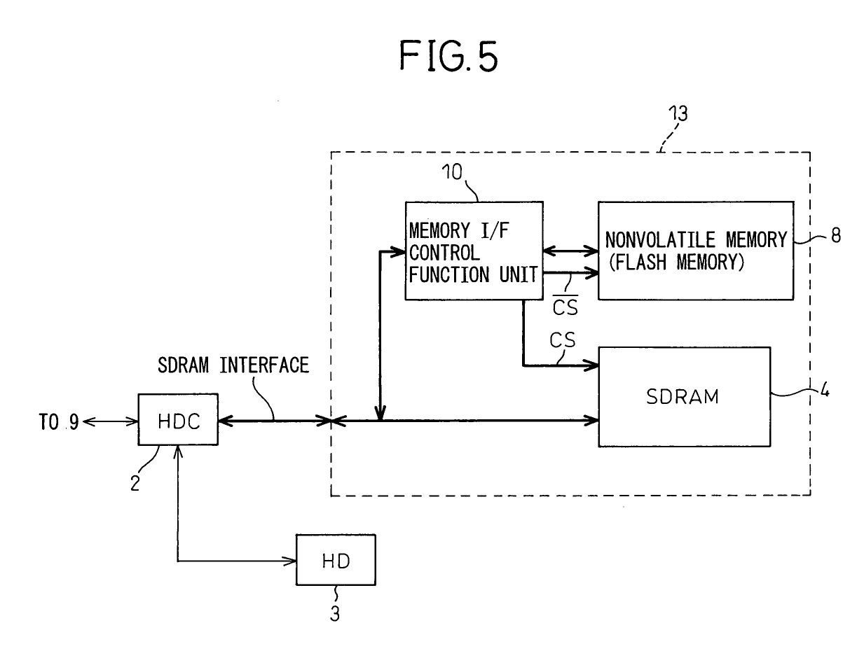

FIG. 5 is a diagram showing the one-chip memory 13 of FIG. 4 in more detail. In this figure, the memory interface (I/F) control function unit 10 functions as an intermediary between the non-volatile memory 8 and the SDRAM interface. When accessing the non-volatile memory 8, the already explained chip select (CS) signal is made the low level (inverse of CS is high). When accessing the SDRAM 4, the CS is made the high level.

This memory I/F control function unit 10 analyzes a command received through the SDRAM interface from the host computer 9 and, if a command for the non-volatile memory 8, changes to interfacing with the non-volatile memory 8.

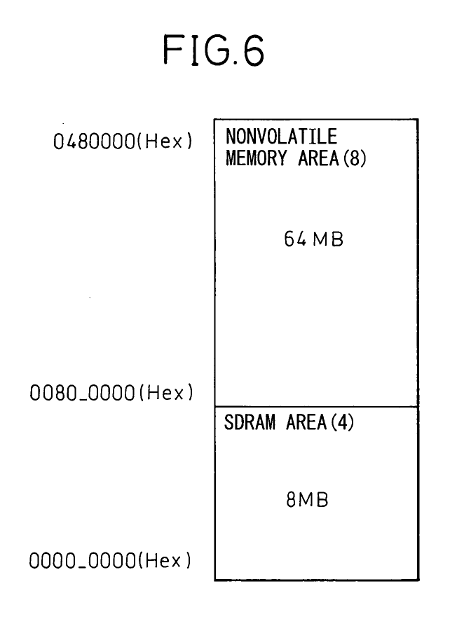

FIG. 6 is a diagram showing an example of the method of selection of the memory 4 and the memory 8 in FIG. 5. In this example, the method of control of the addresses so as to select one of the memories (4, 8) by the addresses is shown.

When the capacity of the SDRAM is for example 8 MB and the capacity of the non-volatile memory 8 is for example 64 MB, the area of the address “0080_{—}0000” (Hex) and higher is set as the area for the non-volatile memory 8. By doing this, when the hard disk controller (HDC) 2 receives a write command for data to the non-volatile memory area (8), the HDC 2 designates an address above “0080_{—}0000” (Hex) in the SDRAM interface. Further, by writing required data into this designated address, the write command can be executed in the non-volatile memory 8. Conversely, when receiving a write command to the SDRAM area (4), the HDC 2 designates addresses of “0000_{—}0000” (Hex) to less than “0080_{—}0000” (Hex) for the SDRAM interface.

Note that the addresses may be decoded and the above-mentioned CS (chip select) signal may be generated by known methods. Further, the CS signal may be controlled at the one-chip memory 13 side as shown in the example of FIG. 5 (corresponding to FIG. 1) or the CS signal may be generated at the HDC 2 side.

Here, an example of the flow of processing of the above write command, in particular a write command in the case based on the T13 proposal, is shown in the figures.

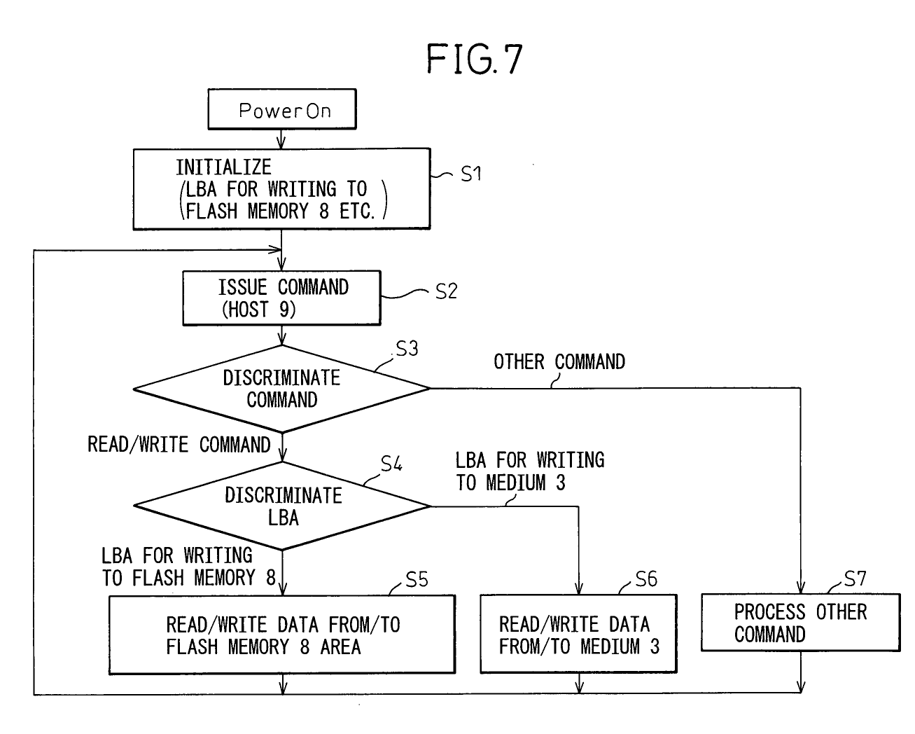

FIG. 7 is a diagram showing an example of the flow of processing for a write command in the case based on the T13 proposal. In the figure, when the hard disk drive (HDD) is turned on (power on),

Step S1: The routine is initialized. As an example, the flash memory 8 is written into, so logical block addressing (LBA) is set for writing into the flash memory 8 (see FIG. 6). Note that the LBA assigns consecutive numbers to the sectors in the hard disk 3 and uses those consecutive numbers to designate the required sectors.

Step S2: After the initialization, the host computer 9 issues a command.

Step S3: Receiving the issued command, the hard disk controller (HDC) 2 judges what kind of command that command is. In this case, it is judged if it is a read/write command for the hard disk 3 or is another command. If the former read/write command,

Step S4: The LBA is judged. In this case, it is judged if the LBA is for writing in the flash memory 8 or the LBA is for writing into the storage medium (HD) 3 through the SRAM 4. Depending on the results of judgment, the routine proceeds to step S5 or step S6.

Step S7: If another command, for example, a seek command, sleep command, standby command, etc., at step S3, processing is performed for that command. After this step S7 and step S5 or step S6, the routine returns to step S2 where the next command is awaited.

In the flow of processing shown in FIG. 7, the memory interface (I/F) control function unit 10 according to the present invention mainly handles the function of step S4. Therefore, the specific configuration of the memory I/F control function unit 10 will be explained.

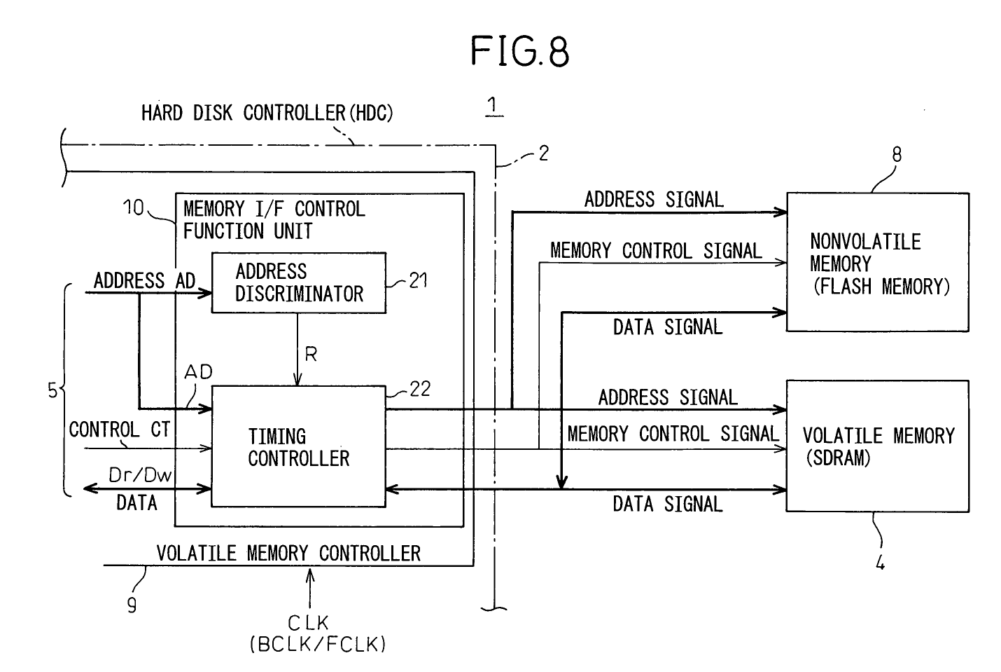

FIG. 8 is a diagram showing a specific example of a memory I/F control function unit 10 in FIG. 2 along with its periphery. That is, a specific example of the case where the memory I/F control function unit 10 is provided in the hard disk controller (HDC) 2 is shown. However, even when the memory I/F control function unit 10 is configured by the first aspect shown in FIG. 1, that is, even when it is configured as shown in FIG. 5, the memory I/F control function unit 10 itself may be configured as shown in FIG. 8.

Referring to FIG. 8, the characterizing parts of the configuration of the present invention will be listed below. First, the signal lines of the illustrated “address signal”, “memory control signal”, and “data signal” when driving the volatile memory 4 and the signal lines of the illustrated “address signal”, “memory control signal”, and “data signal” when driving the non-volatile memory 8 are used in common. Due to this, it is possible to house a new non-volatile memory (flash memory) 8 in the HDC 2 without increasing the number of pins of the conventional hard disk controller (HDC) 2.

Second, the memory I/F control function unit 10 is provided with (i) an address discriminator 21 for receiving address information AD from the host computer 9 and discriminating at least if the address is for the volatile memory 4 or for the non-volatile memory 8 and (ii) a timing adjuster 22 for receiving the address information AD, the result of discrimination R by the address discriminator 21 (including CS or RAS/CAS), and control information CT indicating a write access or read access from the host computer 9 and adjusting any deviation between access timing to the volatile memory 4 and accessing timing to the non-volatile memory 8 for input of write data Dw from the host computer 9 or output of read data Dr to the host computer 9.

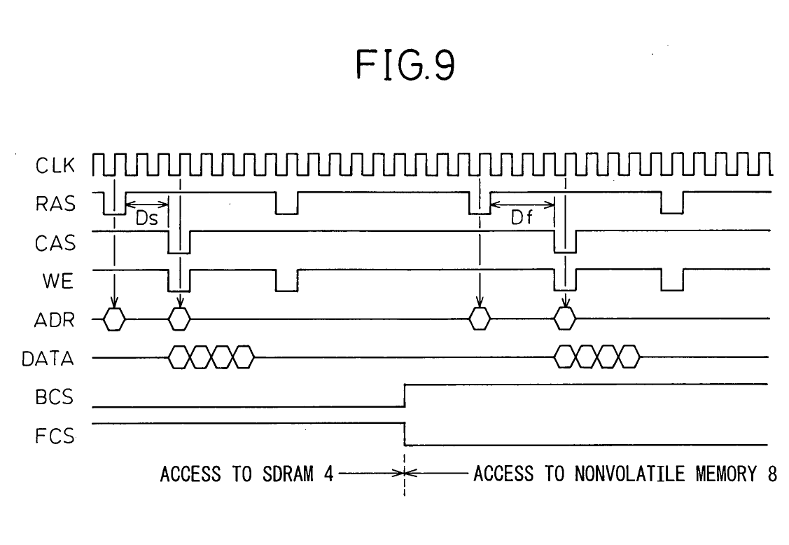

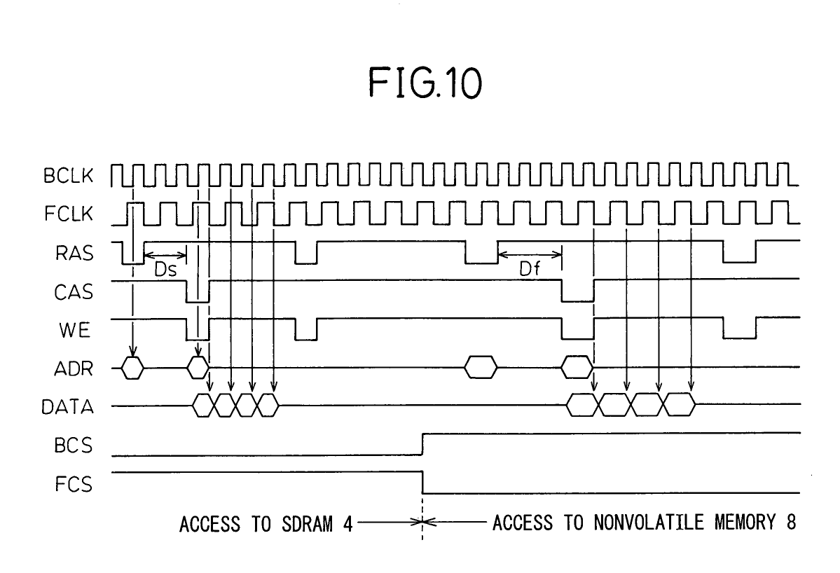

Third, (i) the timing adjuster 22 adjusts the timing in accordance with a common clock (“CLK” of FIG. 8) making the drive clock of the volatile memory 4 and the drive clock of the non-volatile memory 8 the same or (ii) the timing adjuster 22 adjusts the timing by switching between the drive clock of the volatile memory 4 (“BCLK” of FIG. 8) and the drive clock of the non-volatile memory 8 (“FCLK” of FIG. 8). This will be clarified in FIG. 9 and FIG. 10.

FIG. 9 is a timing chart of a first aspect of a main operation of a timing adjuster 22 (by the above “CLK”), while FIG. 10 is a timing chart of a second aspect of a main operation of a timing adjuster 22 (by the above “BCLK/FCLK”)

That is, in FIG. 9, the clock “CLK” is used in common at the SDRAM 4 and the non-volatile memory 8 so as to shift the timing of the “control signal” shown in FIG. 8 (in the illustrated example, RAS->CAS delay) for adjustment between the SDRAM 4 and the non-volatile memory 8. On the other hand, in FIG. 10, clocks are separately provided such as the clock “B (Buffer) CLK” for the SDRAM 4 and the clock “F (Flash) CLK” for the non-volatile memory 8 so as to shift the timing of the “control signal” shown in FIG. 8. Note that the timing charts of FIG. 9 and FIG. 10 are shown for the case of a write command, but similar timing adjustment is performed for the case of a read command or for the case of a combination of a write and read command.

Explaining this in a little more detail, the signal types shown at the left ends of FIG. 9 and FIG. 10 are exactly the same in the two figures except for the topmost row “CLK” and “BCLK/FCLK”. These signal types are:

RAS: Row address strobe

CAS: Column address strobe

WE: Write enable

ADR: Address

DATA: Data

BCS: Buffer chip select

FCS: Flash chip select

In both FIG. 9 and FIG. 10, the left halves shown the operation of “accessing the SDRAM 4”, while the right halves show the operation of “accessing the non-volatile memory 8”.

In FIG. 9 and FIG. 10, the timing between the RAS->CAS delay Ds in the case of accessing the SDRAM 4 and the RAS->CAS delay Df in the case of accessing the non-volatile memory 8 is adjusted. FIG. 9 and FIG. 10 show the case where the SDRAM 4 operates by the general 133 Mbps access speed, while the non-volatile memory (flash memory) 8 operates by the general 100 Mbps access speed. The above adjustment of timing becomes necessary due mainly to this difference in access speeds between the volatile memory (fast) and non-volatile memory (slow).

The above memory apparatus 1 has sufficient characterizing features even in the storage medium controller alone. That is, the storage medium controller 2 is a storage medium controller having at least a volatile memory 4 for temporarily storing data to be transferred between a host computer 9 and a storage medium 3, a host controller 5 for controlling interfacing with the host computer 9, a volatile memory controller 6 for controlling interfacing with the volatile memory 4, and a medium controller 7 for controlling interfacing with the storage medium 3, characterized by being configured to be able to connect to the non-volatile memory 8 compatible for interfacing with the volatile memory 4 through an interface for connecting the volatile memory 4 and the volatile memory controller 6 and being provided with a memory interface control unit 10 for controlling interfacing with the non-volatile memory 8.

Further, regarding the storage medium controller 2, the storage medium 3 is a hard disk, the volatile memory 4 is an SDRAM, the non-volatile memory 8 is a flash memory, and the storage medium controller is a hard disk controller.

Still further, in the storage medium controller 2, the signal lines of the illustrated “address signal”, “memory control signal”, and “data signal” when driving the volatile memory 4 and the signal lines of the illustrated “address signal”, “memory control signal”, and “data signal” when driving the non-volatile memory 8 are used in common.

Further, in the storage medium controller 2, the memory interface (I/F) control function unit 10 is provided with (i) an address discriminator 21 for receiving address information AD from the host computer 9 and discriminating at least if the address is for the volatile memory 4 or for the non-volatile memory 8 and (ii) a timing adjuster 22 for receiving the address information AD, the result of discrimination R by the address discriminator 21 (including CS or RAS/CAS), and control information CT indicating a write access or read access from the host computer 9 and adjusting any deviation between access timing to the volatile memory 4 and accessing timing to the non-volatile memory 8 for input of write data Dw from the host computer 9 or output of read data Dr to the host computer 9.

This timing adjuster 22 adjusts the timing in accordance with a common clock (“CLK” of FIG. 8) making the drive clock of the volatile memory 4 and the drive clock of the non-volatile memory 8 the same.

Alternatively, the timing adjuster 22 adjusts the timing by switching between the drive clock of the volatile memory 4 (“BCLK” of FIG. 8) and the drive clock of the non-volatile memory 8 (“FCLK” of FIG. 8).

As explained above, the present invention has as its object to house a new non-volatile memory 8 without making major changes to the configuration of the hard disk controller (HDC) 2. This object can be achieved by introduction of the “copy controller”.

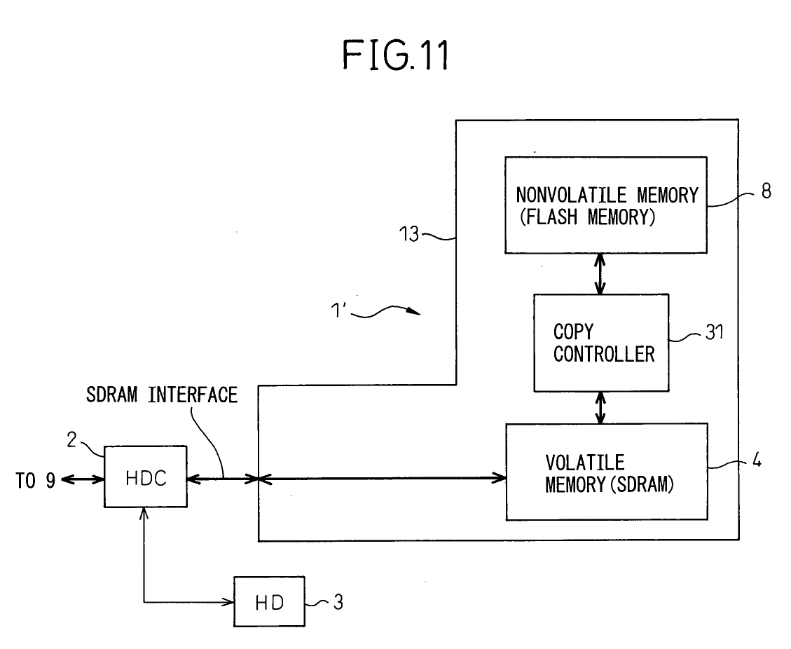

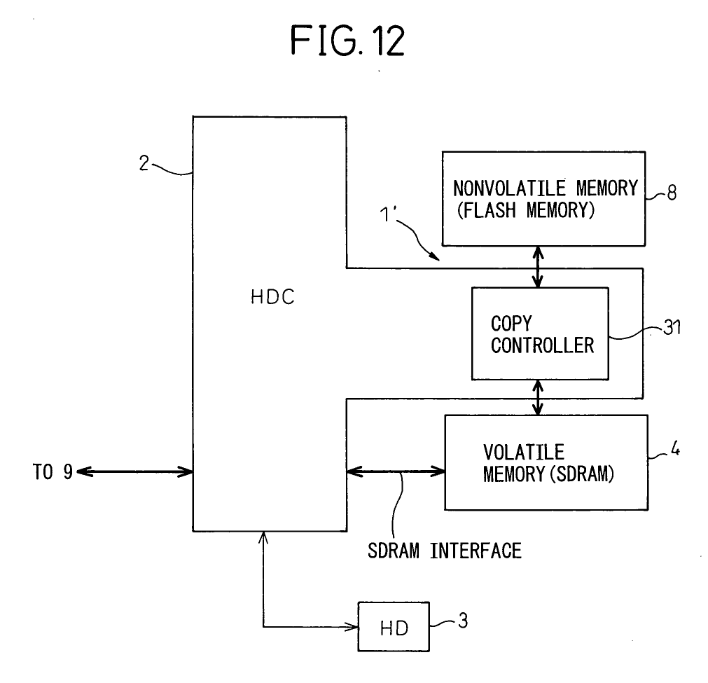

FIG. 11 is a diagram showing a first aspect of a memory apparatus 1′ using a copy controller 31 according to the present invention, and FIG. 12 is a diagram showing a second aspect of a memory apparatus 1′ using a copy controller 31 according to the present invention.

Each of the memory apparatuses 1′ shown in FIG. 11 and FIG. 12 is a memory apparatus 1′ connecting a volatile memory 4 for temporarily storing data to be transferred between the host computer 9 and the storage medium (HD) 3 and a non-volatile memory 8 compatible for interfacing with the volatile memory 4, provided with a copy controller 31 for writing data of the volatile memory 4 in the non-volatile memory 8 or for reading data stored in the non-volatile memory 8 from the non-volatile memory 8 to the volatile memory 4. Here, the characterizing feature of the memory apparatus 1′ shown in FIG. 11 and FIG. 12 is the provision of the copy controller 31 for writing data of the volatile memory 4 in the non-volatile memory 8 or for reading data stored in the non-volatile memory 8 from the non-volatile memory 8 to the volatile memory 4.

Further, the configuration of FIG. 11 is characterized in that the volatile memory 4 and the non-volatile memory 8 are comprised of a one-chip memory 13 integrally providing a volatile memory 4 area and a non-volatile memory 8 area and in that the copy controller 31 is also formed integrally in the one-chip memory 13. On the other hand, the configuration of FIG. 12 is characterized in that the copy controller 31 is formed in the storage medium controller (HDC) 2.

Explaining this further, in the embodiments of FIG. 11 and FIG. 12, a copy controller 31 is inserted between the SDRAM 4 and the non-volatile memory 8 for synchronization and any area of the SDRAM 4 is mirrored in the non-volatile memory 8 for storing data written in the SDRAM 4 in the non-volatile memory 8. If writing data in that area of the SDRAM 4, then copying the data in the non-volatile memory 8 for storage, while the data of the SDRAM 4 will be lost if turning off the power, when the power is again turned on, the copy controller 31 will be able to copy the data in the non-volatile memory 8 to the SDRAM 4. After this, if transferring the data through the host interface to the host computer 9, by the access control shown in FIG. 6, while there will be some overhead, the HDC 2 will be able to access the data without differentiating between the memory 4 and 8, and the currently used HDC 2 will be able to be used without any changes.

While the invention has been described with reference to specific embodiments chosen for purpose of illustration, it should be apparent that numerous modifications could be made thereto by those skilled in the art without departing from the basic concept and scope of the invention.

1. A memory apparatus comprising:
a volatile memory for temporarily storing data to be transferred between a host computer and a storage medium,
an interface able to connect with an interface for connecting with a volatile memory controller for controlling interfacing between the host computer and the volatile memory, and
a non-volatile memory able to compatibly interface with the volatile memory.

2. A memory apparatus as set forth in claim 2, further provided with a memory interface control function unit for controlling interfacing of the non-volatile memory through the volatile memory controller.

3. A memory apparatus as set forth in claim 1, wherein the signal lines of an address signal, memory control signal, and data signal when driving the volatile memory and the signal lines of an address signal, memory control signal, and data signal when driving the non-volatile memory are used in common.

4. A memory apparatus as set forth in claim 2, wherein the memory interface control function unit is provided with an address discriminator for receiving address information from the host computer and discriminating at least if the address is for the volatile memory or for the non-volatile memory and a timing adjuster for receiving the address information, the result of discrimination by the address discriminator, and control information indicating a write access or read access from the host computer and adjusting any deviation between access timing to the volatile memory and accessing timing to the non-volatile memory for input of write data from the host computer or output of read data to the host computer.

5. A memory apparatus as set forth in claim 1, wherein the storage medium is a hard disk, the volatile memory is an SDRAM, the non-volatile memory is a flash memory, and the storage medium controller is a hard disk controller.

6. A memory apparatus as set forth in claim 4, wherein the timing adjuster adjusts the timing in accordance with a common clock making the drive clock of the volatile memory and the drive clock of the non-volatile memory the same.

7. A memory apparatus as set forth in claim 4, wherein the timing adjuster adjusts the timing by switching between the drive clock of the volatile memory and the drive clock of the non-volatile memory.

8. A storage medium controller having at least a volatile memory 4 for temporarily storing data to be transferred between a host computer and a storage medium, a host controller for controlling interfacing with the host computer, a volatile memory controller for controlling interfacing with the volatile memory, and a medium controller for controlling interfacing with the storage medium, characterized by
being configured to be able to connect to the non-volatile memory compatible for interfacing with the volatile memory through an interface for connecting the volatile memory and the volatile memory controller and
being provided with a memory interface control unit for controlling interfacing with the non-volatile memory.

9. A storage medium controller as set forth in claim 8, wherein the storage medium is a hard disk, the volatile memory is an SDRAM, the non-volatile memory is a flash memory, and the storage medium controller is a hard disk controller.

10. A storage medium controller as set forth in claim 8, wherein the signal lines of an address signal, memory control signal, and data signal when driving the volatile memory and the signal lines of an address signal, memory control signal, and data signal when driving the non-volatile memory are used in common.

11. A storage medium controller as set forth in claim 8, wherein the memory interface control function unit is provided with
an address discriminator for receiving address information from the host computer and discriminating at least if the address is for the volatile memory or for the non-volatile memory and
a timing adjuster for receiving the address information, the result of discrimination by the address discriminator, and control information indicating a write access or read access from the host computer and adjusting any deviation between access timing to the volatile memory and accessing timing to the non-volatile memory for input of write data from the host computer or output of read data to the host computer.

12. A storage medium controller as set forth in claim 11, wherein the timing adjuster adjusts the timing in accordance with a common clock making the drive clock of the volatile memory and the drive clock of the non-volatile memory the same.

13. A storage medium controller as set forth in claim 11, wherein the timing adjuster adjusts the timing by switching between the drive clock of the volatile memory and the drive clock of the non-volatile memory.

14. A memory apparatus connecting a volatile memory for temporarily storing data to be transferred between the host computer and the storage medium and a non-volatile memory compatible for interfacing with the volatile memory, comprising
a copy controller for writing data of the volatile memory in the non-volatile memory or for reading data stored in the non-volatile memory from the non-volatile memory to the volatile memory.

15. A memory apparatus as set forth in claim 14, wherein the volatile memory and the non-volatile memory are comprised of a one-chip memory integrally providing a volatile memory area and a non-volatile memory area and the copy controller is also formed integrally in the one-chip memory.

16. A storage medium controller provided with a memory apparatus as set forth in claim 9.
